(19) United States
(12) Patent Application Publication
(10) Pub. No.: US 2008/0048023 A1
(43) Pub. Date: Feb. 28, 2008

(54) GIFT CARD SYSTEM CAPABLE OF RESTRICTING TRANSACTIONS TO PREDESIGNATED ITEMS

(75) Inventors: Riley R. Russell, San Mateo, CA (US); Gary M. Zalewski, Oakland, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment America Inc., Foster City, CA (US)

(21) Appl. No.: 11/467,117

(22) Filed: Aug. 24, 2006

(51) Int. Cl. G06K 5/00; G06Q 40/00

(52) U.S. Cl. 235/380; 705/44

(57) ABSTRACT

A gift card, debit card, or similar instrument and an associated system are capable of restricting purchase transactions to predesignated authorized merchandise or excluding from purchase transactions predesignated unauthorized merchandise. To facilitate this an account that does not permit one or more items or services to be purchased using the account may be established in an account system. The account system receives identification information for an item or service requested for purchase, and the system also receives identification information for the account requested to be used to pay for at least a portion of the item or service requested for purchase. The system determines whether or not the item or service requested for purchase is authorized for purchase using the account. If not, the system denies the use of the account to pay for any portion of the item or service requested for purchase. The scope of the items and/or services authorized for purchase with the card may be set and modified online.

### BACKGROUND OF THE INVENTION

1. Field of the Invention

The present invention relates generally to purchase transactions for goods and services, and more specifically to the use of gift cards, gift certificates, debit cards, etc., for payment in such transactions.

2. Discussion of the Related Art

Gift certificates and gift cards are typically sold by stores and other commercial establishments and are given as gifts. Gift certificates and gift cards entitle the recipient to select merchandise and/or services of an indicated cash value at the store.

Gift cards typically have a barcode or magnetic strip (or “magstripe”) that can be processed through a standard electronic credit card machine, which automates the checkout and accounting processes. Gift cards do not have any value until they are sold, at which time the cashier enters the amount which the customer wishes to put on the card. This number is typically stored in the store's database and is rarely stored on the card itself. There are exceptions, however, such as in many public transport systems and library photocopiers where a simplified system with no network stores the value only on the card itself. Such cards are known as “stored-value” cards.

Many gift cards can also be used for making purchases online at the store's website. Because the card's value is typically stored in the store's database, the recipient of the card simply enters the card number into the website and the value of the card is automatically applied to the purchase amount.

Some credit card companies have also made gift cards available. An advantage of such cards is that they can be used at a variety of different stores and online merchants rather than just one store.

It is with respect to these and other background information factors that the present invention has evolved.

### SUMMARY OF THE INVENTION

The present invention advantageously addresses the needs above as well as other needs by providing a method for use in facilitating a transaction. The method comprises the steps of: establishing an account for use in purchasing items and/or services that is configured so that it cannot be used to pay for unauthorized items and/or services; allowing a user to designate which items and/or services are unauthorized; indicating to a merchant whether or not an item or service requested for purchase is unauthorized; and dispensing funds from the account to pay for all or part of the item or service requested for purchase if it is not unauthorized.

Another embodiment of the present invention provides a system for use in facilitating a transaction. The system comprises: means for establishing an account for use in purchasing items and/or services that is configured so that it cannot be used to pay for unauthorized items and/or services; means for allowing a user to designate which items and/or services are unauthorized; means for indicating to a merchant whether or not an item or service requested for purchase is unauthorized; and means for dispensing funds from the account to pay for all or part of the item or service requested for purchase if it is not unauthorized.

Another embodiment of the present invention provides a method for use in a purchase transaction. The method comprises the steps of: receiving identification information for an item or service requested for purchase; receiving identification information for an account requested to be used to pay for at least a portion of the item or service requested for purchase, wherein the account does not permit one or more items or services to be purchased using the account; determining whether or not the item or service requested for purchase is authorized for purchase using the account; and denying the use of the account to pay for any portion of the item or service requested for purchase if the item or service requested for purchase is not authorized for purchase using the account.

Another embodiment of the present invention provides a system for use in a purchase transaction. The system comprises: means for receiving identification information for an item or service requested for purchase; means for receiving identification information for an account requested to be used to pay for at least a portion of the item or service requested for purchase, wherein the account does not permit one or more items or services to be purchased using the account; means for determining whether or not the item or service requested for purchase is authorized for purchase using the account; and means for denying the use of the account to pay for any portion of the item or service requested for purchase if the item or service requested for purchase is not authorized for purchase using the account.

Another embodiment of the present invention provides a computer program product comprising a medium for embodying a computer program for input to a computer and a computer program embodied in the medium for causing the computer to perform steps of: receiving identification information for an item or service requested for purchase; receiving identification information for an account requested to be used to pay for at least a portion of the item or service requested for purchase, wherein the account does not permit one or more items or services to be purchased using the account; determining whether or not the item or service requested for purchase is authorized for purchase using the account; and denying the use of the account to pay for any portion of the item or service requested for purchase if the item or service requested for purchase is not authorized for purchase using the account.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a flow diagram illustrating a method for use in facilitating a transaction in accordance with an embodiment of the present invention;

FIG. 2 is a flow diagram illustrating a method for use in a purchase transaction in accordance with an embodiment of the present invention; and

FIG. 3 is a block diagram illustrating a system that may be used to run, implement and/or execute the methods shown and described herein in accordance with embodiments of the present invention.

Corresponding reference characters indicate corresponding components throughout the several views of the drawings.

### DETAILED DESCRIPTION

Embodiments of the present invention provide for a gift card, debit card, or the like, and an associated system that is capable of restricting transactions to predesignated items or a class of items. That is, such a card carries restrictions such that certain items, goods and/or services cannot be purchased using the card.

Such a card and system is useful in many different scenarios. For example, in the scenario where a parent gives a gift card to a child, the parent can have the ability to prohibit certain items from being purchased with the card, such as for example, alcoholic beverages, tobacco, adult rated movies, videos, video games, etc. As another example, a manufacturer of branded products may provide gift cards that can only be used to purchase the manufacturer's branded products. If the recipient of the card attempts to purchase another manufacturer's product the purchase will be denied.

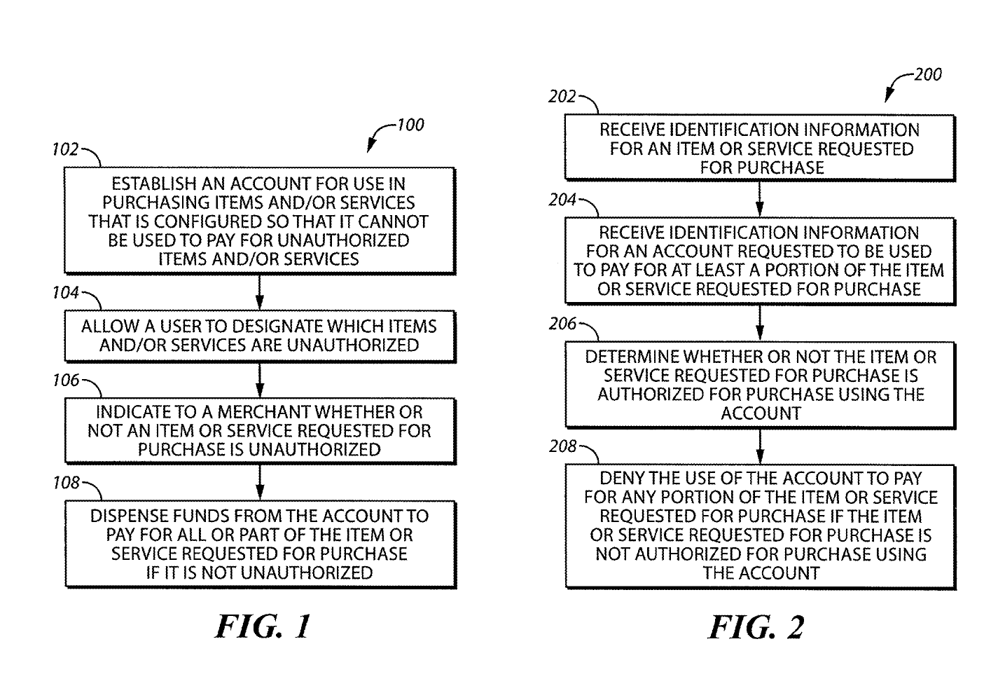

Referring to FIG. 1, there is illustrated a method 100 for use in facilitating a transaction in accordance with an embodiment of the present invention. The method 100 begins in step 102 in which an account is established for use in purchasing items and/or services. The account is configured so that it cannot be used to pay for unauthorized items and/or services.

The account may be associated with a gift card, gift certificate, gift voucher, debit card, credit card, affinity card, or any other similar instrument. In some embodiments the account may be used across multiple retailers. In other embodiments the account may be similar to a traditional gift card in that it only operates at a single retail outlet. Furthermore, in some embodiments the account may be used to purchase items and/or services online.

The account and associated information may be maintained by what is referred to herein as an account system. In some embodiments of the present invention the account system may be located external to the stores and accessible via a network, such as the Internet. In other embodiments the account system may be located within a store or a store's network.

In step 104 a user is allowed to designate which items and/or services are unauthorized. This predesignation may take many different forms. For example, there may be a list of specific items and/or services that are authorized for purchase. In this scenario everything else not on the list would be unauthorized. Or, as another example, there may be a “lockout” list in which specific items and/or services that are not authorized for purchase are listed. In this scenario everything else not on the list would be authorized.

By way of example, embodiments of the present invention may be applied to food stamps. In this scenario the predesignated authorized items may be broad and cover public appropriate uses, such as for example food. Lockout lists could include, for example, items such alcoholic beverages, cigarettes, or other items not appropriate for green-stamp use.

In other embodiments, the unauthorized items and/or services may be identified by a rating associated with the items or services. For example, lockout lists could include movies, videos or video games having an “R” or more restrictive rating. Such embodiments may be useful where a parent gives a gift card to a child.

In some embodiments merchandise that is authorized for purchase may be associated with a global affinity relating to the theme of the card. For example, as mentioned above, a manufacturer's branded card may only allow transactions on that manufacturer's branded items.

This predesignation of items and/or services may occur in a registry database using the SKU (stock keeping unit) method or the like. Furthermore, in some embodiments the ability to initially set up and revise the predesignation of items and/or services may be accessible online via the Internet. This way a user can log in and easily modify which items and/or services are unauthorized, thus changing the scope of the card. For example, a parent could log in to modify the items that are authorized for purchase by his or her child using the gift card. Or, as another example, an executive of a corporation could log in to modify the items that are authorized for purchase using the corporation's branded gift card. This way the executive can have constant control over the scope of the card. This system also makes it easy for a user to set predesignated items associated with one or more cards.

Items designated as authorized for purchase with the card may be added to the card on an individual or global basis. For example, in some embodiments the system is capable of restricting transactions to not only predesignated items but also entire classes of items. In addition, the online access system may be used in some embodiments to replenish card value. In some embodiments the system may be configured so that anyone may replenish another's card.

In step 106 the account system indicates to a merchant whether or not an item or service requested for purchase is unauthorized. The merchant can either be a traditional brick-and-mortar or an online merchant. As will be explained below, the account system will typically receive from the merchant identification information for the item or service requested for purchase and identification information for the account associated with the gift card. The account system then looks up the restricted items associated with the account to determine whether or not the purchase is authorized. As will be discussed below, this intervening look-up to check if the purchase is authorized can be performed locally within a store or via the Internet. The account system then notifies the merchant as to whether or not the requested purchase is authorized to be paid for with the gift card.

Finally, in step 108 the account system checks the balance of the card to see if funds are available, and if so, dispenses funds from the account to pay for all or part of the item or service requested for purchase if it is not unauthorized. In some embodiments the purchaser can choose how much of the available funds are to be used for the purchase, up to the balance of the card.

Such dispensing of funds may take on many different forms. For example, if the account system is similar to a traditional gift card in that it only operates at a single retail outlet, then the dispensing of funds may simply be a matter of internal accounting in the store's databases. On the other hand, if the system is set up to be used across multiple retailers, then the dispensing of funds may be similar to the manner in which credit card companies dispense funds to different stores for payment.

An example of a purchase transaction will now be described. Specifically, referring to FIG. 2 there is illustrated a method 200 for use in a purchase transaction in accordance with an embodiment of the present invention. The method 200 begins with steps 202 and 204. In general, in these steps a point of sale system coordinates with the account system (or other financial authorization system) to transact wherein a lookup event occurs to determine if the item or service requested for purchase matches a predesignated item. If so, the item or service is authorized for purchase under a traditional or modified transaction process.

More specifically, in step 202 the account system receives identification information for an item or service requested for purchase. For example, such information may be received from a point of sale in a traditional brick-and-mortar store. In this scenario the card recipient presents the cashier with the item or service he or she wishes to purchase with the card. The identity of the item or service is entered into the store's computer system by the usual bar code scanning system or the like. The identity information is then sent to the account system via the Internet, a dedicated network, or the like.

As another example, the identification information for an item or service may be received from an online merchant. In this scenario the card recipient selects items or services for purchase and places them in his or her online shopping cart. The identity of the items or services are electronically sent to the account system.

In step 204 the account system receives identification information for an account requested to be used to pay for at least a portion of the item or service requested for purchase. Again, and as described above, the account is configured so that it does not permit one or more items or services to be purchased using the account. The account may be associated with a gift card, gift certificate, gift voucher, debit card, credit card, affinity card, or any other similar instrument.

Similar to the merchandise identity information, the account identify information may be received from a point of sale in a traditional brick-and-mortar store. Since the card may include a magnetic strip, the card may be “swiped” like a credit card with the information being sent to the account system via the Internet, a dedicated network, or the like. In other embodiments the card may be bar coded, include a printed account number, include radio frequency identification (RFID), or some other suitable means of identification.

The account identity information may also be received from an online merchant. In this scenario the card recipient may enter the account number into the online merchant's website with the information being electronically sent to the account system.

In step 206 the account system determines whether or not the item or service requested for purchase is authorized for purchase using the account. For this step the system uses the account identity information to look up the restricted items and/or services associated with the account. The system then uses the merchandise identity information to determine whether or not the purchase is authorized. The system then notifies the merchant as to whether or not the requested purchase is authorized to be paid for with the gift card.

Finally, in step 208 the account system denies the use of the account to pay for any portion of the item or service requested for purchase if the item or service requested for purchase is not authorized for purchase using the account. On the other hand, if the item or service requested for purchase is authorized for purchase using the account, the purchase is approved and funds from the account may be used to pay for any portion of the purchase. For example, there may not be enough funds on the card to pay for the entire purchase. In this case all or part of the funds may be used to pay for any portion of the authorized items or services.

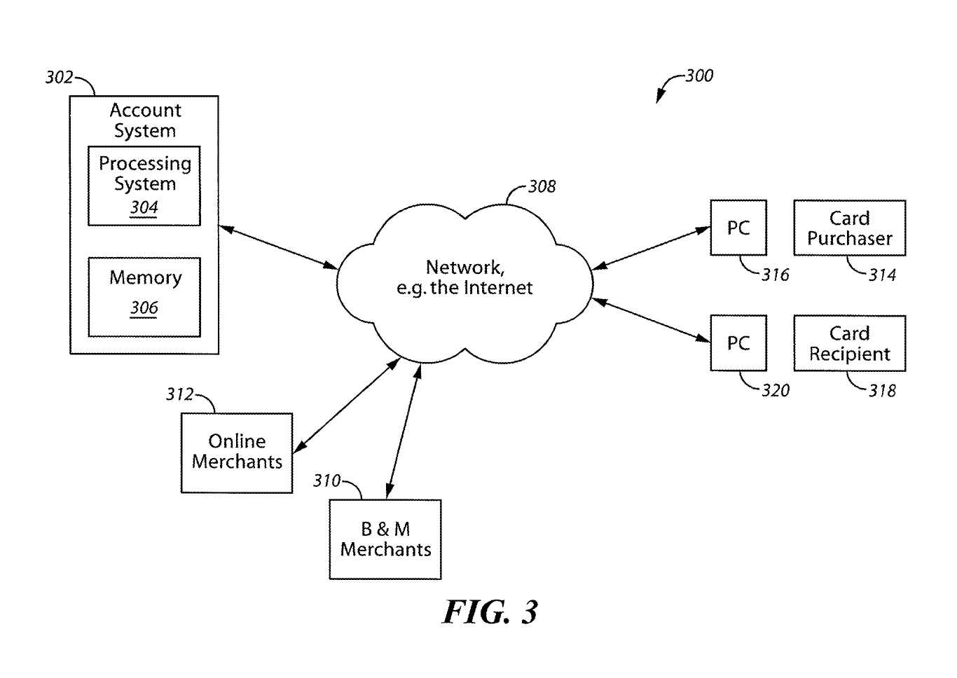

Referring to FIG. 3, there is illustrated a system 300 that may be used to run, implement and/or execute the methods 100 (FIG. 1) and 200 (FIG. 2) in accordance with embodiments of the present invention. The system 300 includes and account system 302 for maintaining the account and associated information, including the predesignated unauthorized items and services. The account system 302 may, for example, include a processing system 304 and memory 306 for accomplishing the tasks described above. The memory 306 may be used to store a database and/or accounting information and/or software configured to implement the methods and techniques described herein. The memory 306 may comprise any type of memory, such as RAM, ROM, hard disk drive, CD or DVD drive, USB drive, etc.

The account system 302 is connected to a computer network 308, such as the Internet. Any number of traditional brick-and-mortar merchants 310 and online merchants 312 will typically have access to the network 308 and thus the account system 302.

A card purchaser 314 may purchase the card in person at, for example, one of the brick-and-mortar merchants 310, or the card purchaser 314 may purchase the card online using a personal computer (PC) 316, or the like. The card purchaser 314 may also use the (PC) 316 to set or modify the scope of the card as described above and/or to replenish the card.

A card recipient 318 may use (i.e. redeem) the card in person at, for example, one of the brick-and-mortar merchants 310, or the card recipient 318 may redeem the card online using a PC 320, or the like. The transactions may operate as described above. The card recipient 318 may also use the (PC) 320 to check the balance on the card.

In some embodiments of the present invention, automatic purchases can occur via stored wish lists when appropriate funds are available on the card. In these scenarios, the card recipient 318 will log into the account system using the PC 320 and enter his or her wish list.

The account system 302 is illustrated as being located external to the brick-and-mortar merchants 310 and online merchants 312. It should be well understood, however, that the account system 302 may alternatively be located internal to any of the brick-and-mortar merchants 310 and/or online merchants 312. Or, in other embodiments of the present invention, some or all of the data stored in the account system 302 may be downloaded to any of the brick-and-mortar merchants 310 and/or online merchants 312 and stored locally. This way, the intervening look-up to check if a purchase is authorized can be performed locally within a store. The data may be downloaded or updated on a periodic basis so that the most recent data is available. Similarly, in other embodiments, a bank, credit card company, or other institution may download some or all of the data stored in the account system 302 so that these institutions may also perform the intervening look-ups locally.

While the invention herein disclosed has been described by means of specific embodiments and applications thereof, numerous modifications and variations could be made thereto by those skilled in the art without departing from the scope of the invention set forth in the claims.

What is claimed is:

1. A method for use in facilitating a transaction, comprising the steps of:
establishing an account for use in purchasing items and/or services that is configured so that it cannot be used to pay for unauthorized items and/or services;
allowing a user to designate which items and/or services are unauthorized;
indicating to a merchant whether or not an item or service requested for purchase is unauthorized; and
dispensing funds from the account to pay for all or part of the item or service requested for purchase if it is not unauthorized.

2. A method in accordance with claim 1, wherein the account is associated with a gift instrument.

3. A method in accordance with claim 1, wherein the account comprises a debit account.

4. A method in accordance with claim 1, wherein the step of allowing a user to designate which items and/or services are unauthorized can be performed online using the Internet.

5. A method in accordance with claim 1, wherein the unauthorized items and/or services are indicated by not being a part of a class of authorized items or services.

6. A system for use in facilitating a transaction, comprising:
means for establishing an account for use in purchasing items and/or services that is configured so that it cannot be used to pay for unauthorized items and/or services;
means for allowing a user to designate which items and/or services are unauthorized;
means for indicating to a merchant whether or not an item or service requested for purchase is unauthorized; and
means for dispensing funds from the account to pay for all or part of the item or service requested for purchase if it is not unauthorized.

7. A system in accordance with claim 6, wherein the account is associated with a gift instrument.

8. A system in accordance with claim 6, wherein the account comprises a debit account.

9. A system in accordance with claim 6, wherein the means for allowing a user to designate which items and/or services are unauthorized comprises means for performing the designation online using the Internet.

10. A method for use in a purchase transaction, comprising the steps of:
receiving identification information for an item or service requested for purchase;
receiving identification information for an account requested to be used to pay for at least a portion of the item or service requested for purchase, wherein the account does not permit one or more items or services to be purchased using the account;
determining whether or not the item or service requested for purchase is authorized for purchase using the account; and
denying the use of the account to pay for any portion of the item or service requested for purchase if the item or service requested for purchase is not authorized for purchase using the account.

11. A method in accordance with claim 10, wherein the account is associated with a gift instrument.

12. A method in accordance with claim 10, wherein the account comprises a debit account.

13. A method in accordance with claim 10, wherein the account is configured to allow a user to designate the one or more items or services that are not permitted to be purchased using the account.

14. A method in accordance with claim 10, wherein the one or more items or services that are not permitted to be purchased using the account can be designated using the Internet.

15. A method in accordance with claim 10, wherein the one or more items or services that are not permitted to be purchased using the account are indicated by not being a part of a class of authorized items or services.

16. A system for use in a purchase transaction, comprising:
means for receiving identification information for an item or service requested for purchase;
means for receiving identification information for an account requested to be used to pay for at least a portion of the item or service requested for purchase, wherein the account does not permit one or more items or services to be purchased using the account;
means for determining whether or not the item or service requested for purchase is authorized for purchase using the account; and
means for denying the use of the account to pay for any portion of the item or service requested for purchase if the item or service requested for purchase is not authorized for purchase using the account.

17. A system in accordance with claim 16, wherein the account is associated with a gift instrument.

18. A system in accordance with claim 16, wherein the account comprises a debit account.

19. A system in accordance with claim 16, further comprising means for allowing a user to designate the one or more items or services that are not permitted to be purchased using the account.

20. A computer program product comprising a medium for embodying a computer program for input to a computer and a computer program embodied in the medium for causing the computer to perform steps of:
receiving identification information for an item or service requested for purchase;
receiving identification information for an account requested to be used to pay for at least a portion of the item or service requested for purchase, wherein the account does not permit one or more items or services to be purchased using the account;
determining whether or not the item or service requested for purchase is authorized for purchase using the account; and
denying the use of the account to pay for any portion of the item or service requested for purchase if the item or service requested for purchase is not authorized for purchase using the account.

21. A computer program product in accordance with claim 20, wherein the account is associated with a gift instrument.

22. A computer program product in accordance with claim 20, wherein the account comprises a debit account.

23. A computer program product in accordance with claim 20, wherein the account is configured to allow a user to designate the one or more items or services that are not permitted to be purchased using the account.

24. A computer program product in accordance with claim 20, wherein the one or more items or services that are not permitted to be purchased using the account can be designated using the Internet.
